(19) United States
(12) Patent Application Publication
(10) Pub. No.: US 2004/0193425 A1
(43) Pub. Date: Sep. 30, 2004

(54) Marketing a business employing voice and speech recognition technology

(76) Inventor: Christopher B. Tomes, Chicago, IL (US)

Correspondence Address: Bell, Boyd & Lloyd LLC, P. O. Box 1135, Chicago, IL, 60690-1135, US

(21) Appl. No.: 10/712,973

(22) Filed: Nov. 12, 2003

Related U.S. Application Data
(60) Provisional application No. 60/425,428, filed on Nov. 12, 2002.

(51) Int. Cl. G10L 11/00; G10L 21/00

(52) U.S. Cl. 704/273

(57) ABSTRACT

Devices, apparatuses, systems, methods and the like for marketing, promoting and/or advertising a business or product are provided. The present invention combines applications such as screen savers, desktop assistants and instruction with voice verification technology in a readily installable and operable computer form. The voice interactive applications include visual imagery to attract a user/customer(s) to activate and interact with the application. Once activated, the application prompts the consumer user for voice input. The voice input, once authenticated, can then be processed to interact with a product character to perform tasks such as connecting the consumer user to a web-site associated with the advertised business via a hyperlink. Interaction with the product character in a variety of voice interactive applications provides the consumer user with ready and easy access to further product information, product purchasing capabilities, business contact information, updates on promotional products, and/or the like to facilitate the marketing, promoting and/or advertising of the business.

### PRIORITY CLAIM

This application claims the benefit of U.S. Provisional Application No. 60/425,428 filed Nov. 12, 2002.

The present invention relates to marketing, promoting and/or advertising a business and/or a product. More specifically, the present invention relates to devices, apparatuses, systems and methods for marketing, promoting and/or advertising a business through voice verification technology.

### BACKGROUND OF THE INVENTION

Businesses market products to consumers by using symbols or other visual indicia to represent the business and its products. These symbols or indicia serve as trademarks, brands, and/or logos which consumers use to identify a business or product. In many cases, such symbols or indicia include animations or spokespersons which are identified with the business and/or its products. For example, the well-known clown, Ronald McDonald, represents the hamburger franchise, McDonalds, and its products. Generally, a business attempts to create recognition among its target consumer population of its brand and/or product character to distinguish its products from other products in the market and to create an expectation of quality associated with the business or product. Additionally, product characters are used to attach a personality to the product for the purpose of translating consumer familiarity with and appreciation of the product character into consumer familiarity with and appreciation of the product itself.

In a seemingly unrelated field, voice or speech recognition technology has been used in applications in the form of biometric identification to identify a user, converting speech or sound to text, and controlling digital functions within software applications. Speech recognition technology has been utilized in lieu of passwords, pre-programmed letter and/or number combinations, or other forms of imitatable identification. Speech recognition technology has been utilized to allow a user to input and text through voice commands into computers or other devices. Voice commands are typically processed to convert the sound to text to enable the creation of documents, e-mail messages, or other written applications without the use of input from a keyboard. The voice command can also be used, in general, to control computer-related applications such as automated telephone answering systems to route calls through a selection menu to a proper destination.

Until now, voice or speech recognition technology has not been integrated with marketing techniques to provide verbally interactive marketing campaigns wherein consumers can establish one-to-one “relationships” with product spokespersons or animated characters. A need, therefore, exists to provide and combine the capabilities of speech or voice recognition-related technologies for business marketing, promotional and/or advertising purposes.

### SUMMARY OF THE INVENTION

The present invention provides improved devices, apparatuses, systems, and methods for marketing, promoting, and/or advertising a business or the like. In particular, the present invention employs an interactive presentation based on a marketing theme or promotion which responds to and/or is activated by the recognition of the voice of a consumer user and controlled by speech recognition of verbal commands entered by the consumer user. This interactive promotional software can provide a promotional presentation and/or can be incorporated into any operating system, application or electronic device to provide the consumer user voice interactive functionality within the context of a business promotional theme or environment.

Voice verification of a previously recorded and stored voice input by the consumer user allows the present invention to provide a promotional presentation customized to the individual consumer user. The promotional presentation may include a text display, a movie or animation clip, and/or other like visual imagery to provide an audio, video or multi-media presentation to the consumer user. In addition, the interactive promotional software may be adapted to activate a hyperlink via the Internet which directs the consumer user to a web-site associated with the business for the promotional presentation and/or for conducting business-related activities. Business activities may include reviewing product and/or service information, purchasing same, and/or the like.

One or more brand visuals, logos, product characters or the like associated with a business or product may be used to facilitate the business marketing, promotional and/or advertising presentation. Additionally, the product character associated with the promoted product or business can encourage the interaction of the consumer user with the software. The product character, for example, can interact with the consumer user to perform tasks in a computer-operating environment and other media-delivering electronic devices, such as televisions, pda's and cell phones, in response to the recognized voice commands of the consumer user.

In one embodiment of the invention, the interactive promotional software combines voice and speech recognition technology with software applications to form voice interactive applications which combine the functionality of the voice interactive application with the business marketing, promotional and/or advertising presentation. Voice interactive applications may utilize a product character to perform any one of a series of predetermined tasks in response to the recognized voice commands of the consumer user. For example, in an interactive application which combines screen saver and voice verification technology, the screen saver presents a text display, a movie or animation clip, and/or other like visual imagery to provide a multi-media marketing, promotion and/or advertising presentation. The multi-media presentation becomes active whenever a typical screensaver display is normally displayed. The multi-media presentation may include an interactive product character to interact with the consumer user. Further, the product character can interact with the consumer user to suspend the screen saver mode and to transition the consumer user to a web-site of the advertising business. The product character may serve as an office or desktop assistant, or any other functionality provided in an operating system environment, software applications, or device electronics. The product character may also be utilized in a promotional game wherein interactions between the product character and the consumer user advance the course of the game.

Speech recognition capabilities allow the product character to interact with the recognized voice commands of the consumer user. Via this mechanism, the product character provides promotional instruction in the form of an educational lesson or other interactive activity between the product character and the consumer or user. Similarly, the product character is used in one embodiment to present product information or tutorials. It should be appreciated that the product information can include any information about the product such as background information, general operating instruction, specific uses of the product, advantages of the product, technical specifications or any other information the advertising business desires to provide to the consumer or user.

In an embodiment, a computer program is stored on a medium adapted to be read by a computer processing device which operates a voice interactive application for business promotion. The computer program includes computer readable code for the voice interactive application, computer readable code for executing a plurality of commands to activate the voice interactive application, and computer readable code for running the voice interactive application.

In another embodiment of the invention, an apparatus for business promotion is provided. The apparatus includes a device adapted to operate a voice interactive application. The apparatus can be employed within a system for business promotion.

A novel method for business promotion is also provided. The method includes the steps of providing a device adapted to operate a voice interactive application wherein the device is capable of prompting, receiving and processing voice input. Voice commands are input into the device and activate the voice interactive application.

Additional features and advantages of the present invention are described in, and will be apparent from, the following Detailed Description of the Invention and the figures.

### BRIEF DESCRIPTION OF THE FIGURES

FIG. 1 illustrates a set-up flowchart of a voice interactive application according to an embodiment of the present invention.

FIG. 2 illustrates an operational flowchart of a voice interactive application according to an embodiment of the present invention.

FIG. 2 illustrates an operational flowchart of a voice interactive application according to an embodiment of the present invention.

FIG. 3 illustrates an editing console flowchart of a voice interactive application according to an embodiment of the present invention.

FIG. 4 illustrates a product character interacting with a consumer user to perform a software-related task according to an embodiment of the present invention.

### DETAILED DESCRIPTION OF THE INVENTION

The present invention generally relates to employing voice and speech recognition technology in interactive promotional software to enhance the marketing, promoting and/or advertising efforts of a business. In particular, the present invention relates to devices, apparatuses, systems and methods for providing customer interactive marketing and/or advertising campaigns through voice verification and speech recognition technology. The present invention can be configured in a number of suitable and desirable ways to provide an overall multi-media and product promotion that employs voice input, voice activation and synthesized voice interaction in order to capture the attention of its consumer users of all ages and promote brand awareness and loyalty.

The interactive promotional software can include both voice and speech recognition technologies. Voice recognition technology is used by the present invention for activation of the interactive promotional software and for identification of the consumer user to provide a presentation customized to the individual consumer user. Speech recognition technology is applied in the present invention in voice interactive applications which allow the consumer user to interact verbally with interactive applications incorporating a marketing and/or advertising theme. The speech recognition technology and the voice interactive applications provide a unique combination of functionality for improved business marketing, promotional and/or advertising purposes.

The interactive promotional software includes visual imagery conveying marketing, promotional and/or advertising information related to the business. The interactive promotional software can further include a multi-media presentation based on the marketing theme or promotion through audio and visual effects controlled by the recognition of the voice of the consumer user. The audio-visual effects can include three-dimensional animation as well as full motion virtual multi-media. It should be appreciated that the interactive promotional software can utilize other visual images such as, text, animation, movie clips and/or the like to capture the attention of the consumer user and encourage interaction. The visual images can include, for example, dynamic images, such as a brand visual, logo, product character, and/or any other suitable means of identifying the business or the product.

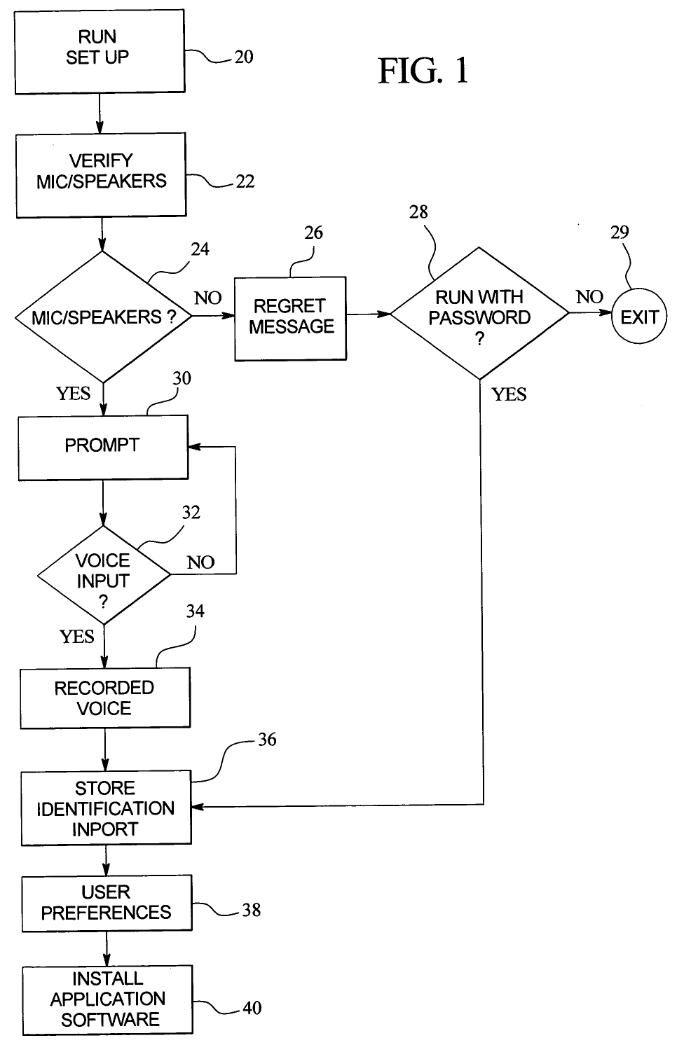

In an embodiment, the interactive promotional software is interfaced with voice recognition technology to provide a promotional experience customized to the consumer user and/or to interact with the consumer user in a personalized manner in the operation of an associated application. FIG. 1 illustrates a flow diagram describing the set-up of a voice interactive application according to an embodiment of the invention. As illustrated in step 20, a set-up program is initiated to enable the consumer user to prepare the voice recognition feature of the application for future voice input by the consumer user. The program first checks for the presence of an input device such as a microphone or any suitable sound detection device, as illustrated in steps 22 and 24. If no input device is detected or confirmed by the consumer user, the program provides the consumer user with the opportunity to enter a password instead of a voice input, as illustrated in steps 26 and 28. If the consumer user enters a password, the password is stored for later comparison to a password input, as illustrated in step 32. Otherwise, the consumer user exits the set-up program, as illustrated in step 38. If an input device is detected or confirmed by the consumer user, the voice interactive application prompts the consumer user to make a unique entry or input such as a voice or any other suitable sound through the user interface such as a microphone, as illustrated in step 29. The user interface is operably connected to software which digitally records the input of the consumer user, as illustrated in steps 32 and 34, and stores the sound electronically, as illustrated in step 36. Unique characteristics of the voice entry are processed by voice verification software for comparison to subsequent sound entries to identify the consumer user and match commands and responses made by the consumer user in subsequent prompts by the software. Once the voice input or password input has been stored, the consumer user is enabled to save preferences specific to the operation of the application as illustrated in step 38. At this point, the application is prepared for installation as illustrated in step 40.

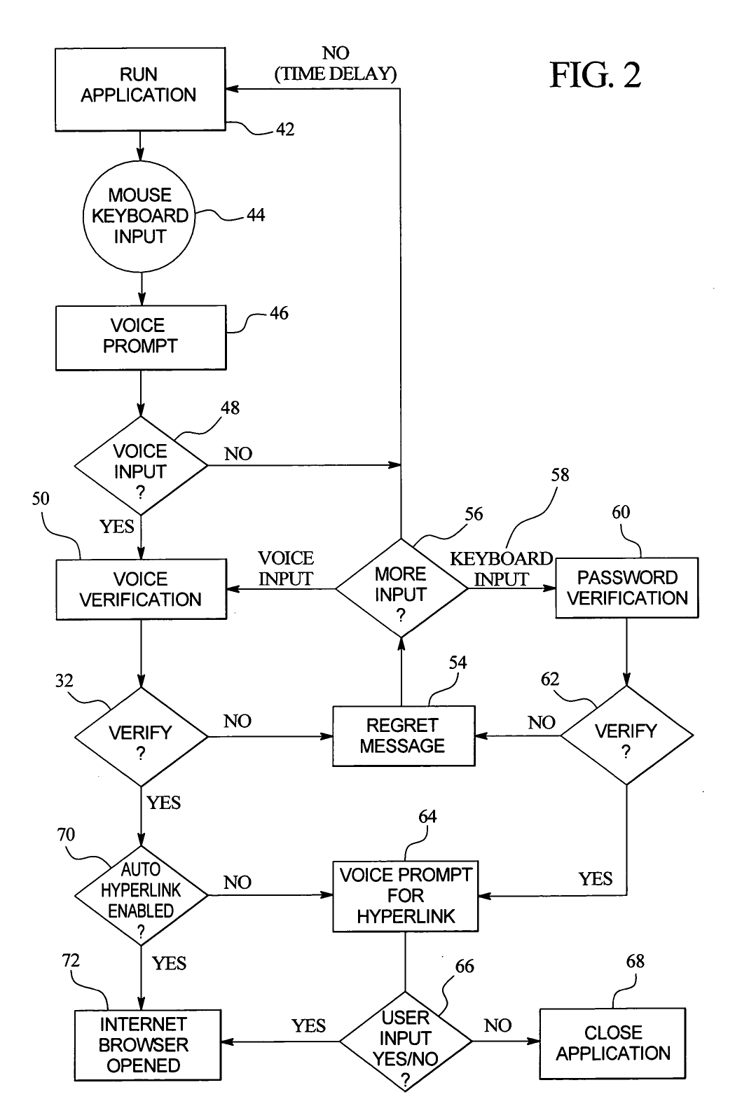

A voice command of the consumer user subsequently input and recognized by the interactive promotional software can activate the interactive promotional software. FIG. 2 illustrates an example of an interactive process with a voice interactive application through verbal commands to control and to otherwise interact with a visual component of the application. The steps can include initiating the application, as illustrated in step 42. An input by the consumer user through a mouse or keyboard input, as illustrated in step 44, triggers a text message, voice message and/or the like. As illustrated in step 46, the text message, voice message or the like triggered in step 44 prompts the consumer user to provide the pre-recorded voice input from the set up process illustrated in FIG. 1. The voice input of the consumer user can be provided via a voice input device, such as a microphone or the like. Alternate user verification methods may also be employed. The voice input or other verification data is then processed and compared to the pre-recorded input described in FIG. 1 with the voice verification technology. If the voice input or other data is authenticated, the consumer user may be prompted again for another voice input, as illustrated in step 52. If no match to the voice input occurs, the application can require additional input including additional voice input, as illustrated in steps 56, 60, and 62. However, the present invention can be modified to allow the consumer user to bypass the voice activation mode, thus allowing the consumer user access via keyboard or other suitable input device as illustrated in steps 56, 58, 60, and 62.

Once the consumer user has been identified, a promotional presentation customized to that user and/or a promotional theme combined with functionality of a voice interactive application is activated and provided to the consumer user. As illustrated in step 64 of FIG. 2, the consumer user is asked if he or she would like to be connected via hyperlink to a web-site related to the advertised business.

If the consumer user provides a recognized voice command in the affirmative, as illustrated in step 66, the consumer user is connected to the hyperlinked web-site, as illustrated in step 72. Otherwise, if the consumer user provides a recognized voice command in the negative, the application can close, as illustrated in step 68. It should be appreciated that the present invention can be configured to directly connect the consumer user to the web-site via an automatic hyperlink upon voice authentication, as illustrated in step 70. This can be done without the use of the keyboard, thus facilitating use of same. It should be also appreciated that the interaction with the computer user can include the product character or other visual component thereby further incorporating the promotional theme within the function of the application.

Once the consumer user gains access to the business web-site through voice authentication or password in the example illustrated in FIG. 2, the interactive promotional presentation may be presented to the consumer user via the internet or other network. In addition, the web-site can include product information, product-purchasing capabilities, business contact information, update promotions, new and updated applications which are downloadable and/or the like.

In one embodiment, the web-site may be configured to provide the consumer user with the ability to order a product through additional voice input. The ordered product can also be sent as a gift to another party. In this case, the consumer user may be able to send a message along with the gift. The message can be entered by voice input and can generate a print message to be delivered with the gift and/or can generate a message to be sent via email. If sent electronically, the message can also include promotional products or downloadable access to promotional products from the company. For example, the message may be sent along with a promotional screen saver application that displays a calendar. The consumer user can use the calendar to input a person(s) and date(s) upon which time a gift can be sent to that person. In this regard, the calendar acts as a reminder to prompt the consumer user to purchase products which may or may not be associated with the advertising business, such as flowers, that can be sent as gifts to friends and/or family.

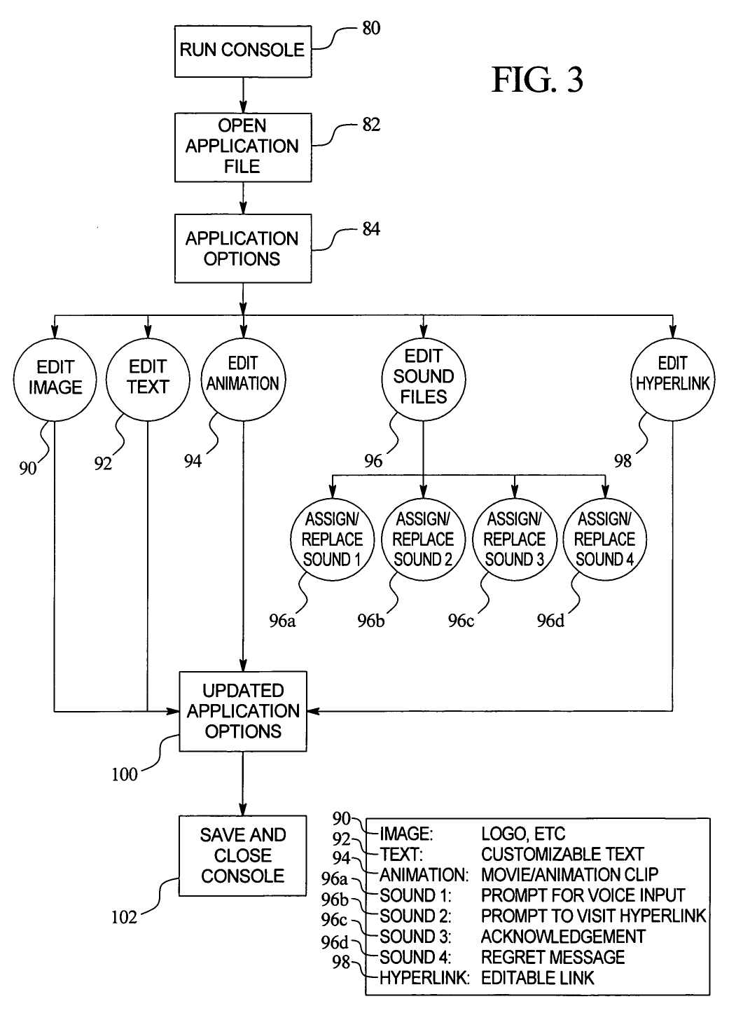

As illustrated in FIG. 3, the voice interactive applications of the present invention can be edited and/or modified according to the preferences of the consumer user identified by the voice verification technology. In this regard, the present invention can be readily customized to meet the specific needs of the business in order to facilitate consumer user interaction with the voice interactive application. FIG. 3 illustrates an example of an editing console used in an embodiment of the present invention in which the consumer user is connected via hyperlink to a web-site. As illustrated in steps 80 and 82, upon running the editing console, the application is opened to provide a menu of preferences to be customized by the consumer user, as illustrated in step 84. It should be appreciated that the preferences provided to the consumer user will vary with each application. Examples of application options which can be edited and modified by the consumer user include images, logos, product characters, or any other visual component, as illustrated in component 90; text, as illustrated in component 92; animation or movie clips, as illustrated in component 94; sound files, as illustrated in component 96; or one or more hyperlinks, as illustrated in component 98. As illustrated in components 96a, 96b, 96c and 96d, the sound files, such as prompting for voice input, prompting to visit a hyperlink, acknowledgment and regret messages, can be assigned and/or replaced. Once the voice interactive activation options are updated, the console can close as illustrated in steps 100 and 102, respectively.

Additionally, the interactive promotional software can be edited, modified and/or updated through a web link. It should be appreciated that the update can be performed automatically upon establishment of a web link or can be in the form of a prompt to the consumer user to update the existing software. The present invention contemplates, for instance, updating features, such as refinements to the voice recognition features, along with updates to the promotional and marketing materials incorporated in the software application.

Each embodiment of the present invention may include a visual component associated with the promoted business or product which is adapted to interact with the computer user. Interactive visual components may include dynamic images, such as a brand visual, logo, product character, and/or any other suitable means of identifying the business or the product.

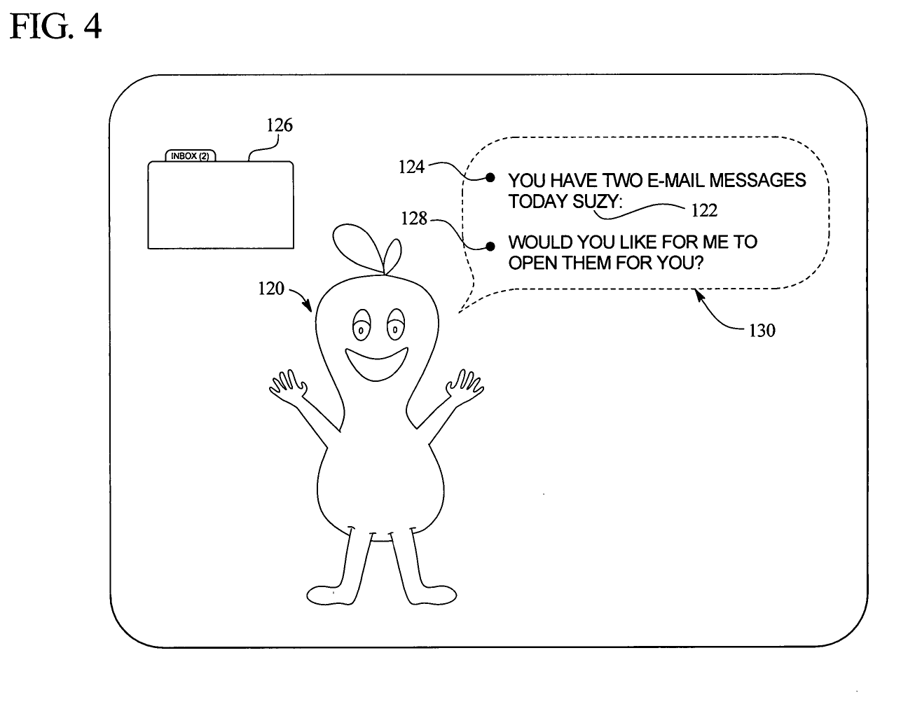

For example, the product character, or animated trademark or company logo can be adapted to work with the application software to provide information related to the application, to personally address the consumer user when providing information, and/or to make any inquiries through audio and visual interaction. One embodiment of the present invention includes a product character which, in response to a sound input which matches a previously stored input, performs any one of a series of predetermined tasks. The predetermined tasks are programmed to be initiated by the product character or in response to the recognized voice command of the consumer user. The product character interacts with the consumer user by seeking input from the consumer user and by prompting the consumer to provide a voice input. FIG. 4 illustrates an example of the interaction of a product character 120 with a consumer user. As illustrated in FIG. 4, the product character 120 can refer to the consumer user by name, e.g., “Suzy” 122 based on the voice verification of Suzy as the consumer user. Additionally, the product character can serve as a functional component in the voice interactive application. For example, a product character, trademark, corporate logo or other animated visual component may be incorporated into an application for managing e-mail. When the user receives an e-mail message, a mailbox icon 126 is displayed. The product character 120 in FIG. 4, for example, can inform the consumer user that he or she has unread mail and the number of unread messages in her e-mail inbox. This information is communicated verbally by the product character as indicated by the speech bubble 130 in FIG. 4. For example, in FIG. 4, the character informs the user that she has email at 124. Subsequently, the product character 120 can offer to perform a task for the consumer user such as opening or displaying the new messages as shown at 128 based on the speech recognition of the voice command provided by the consumer user. It should be appreciated that the interactive communication 130 can be in audio form, wherein a synthesized voice is associated with the product character which can become recognizable to the consumer user after multiple interactions. Alternatively, the interactive communication 130 of the product character can be visual using a text message or other visual form of communication. Moreover, the interactive communication 130 can be both audio and visual.

The product character may further be used in other voice interactive applications such as a desktop assistant which is enabled to perform operating system-related tasks such as opening, saving and re-opening documents and other files, launching application programs, and the like in response to recognized voice commands of the consumer user. The response may include either an audio or video response or both from the product character depending on the circumstances as well as the execution of the desired commands. The product character, for example, may provide an audio response to the command such as “Coming right up”, or the product character may provide an audio follow-up question such as “From what day would you like to view your e-mail?”.

As discussed above, the software features, tasks and promotions can all be updated. In this regard, the appearance of the product character can be controlled by the computer clock and calendar enabling the product character to appear on particular days or at particular times. Through web-linked updates coordinated with the calendar and clock of an electronic device, the business is able to time the appearance of the promotion and/or the product character to correspond with advertised events such as the announcement of a new product, upgrades to existing products, limited time offers, and other time-sensitive promotions. The consumer user can then be periodically reminded as the expiration of the offer draws near.

In an alternative embodiment, the product character is presented in a game which utilizes the recognized voice command of the consumer user. The game is played through interactions between the product character and the consumer user to advance the game.

In another alternative embodiment, the product character interacts with the recognized voice command of the consumer user to provide promotion instruction as product information or as a general educational lesson. In one embodiment, general educational instruction is made available to consumers in a series of lessons offered on a periodic basis such as every week, whenever a product update occurs, or at any other time period. The promotion instruction can be distributed to the consumer user in physical form such as CD, Mini-Disc, DVD, or other transportable media, or in electronic form, such as a web link, or wireless link.

The product character, in one embodiment, presents a language lesson. The product character reads a word, a phrase or a sentence to the consumer user prompting the consumer user to recite the words back. The voice-recognition software detects if the consumer user recites the word, phrase or sentence correctly and enables the product character to respond accordingly, such as “Congratulations Suzy” or “Let's try that again.” Successful attempts by the consumer user in the promotion instruction software advances the consumer user through the current lesson and through other subsequent lessons provided to the consumer user. In one embodiment, prizes such as sweepstakes entries or any other suitable incentives are provided to the consumer user upon installing the software, completing a lesson, or accomplishing any suitable task to reward the consumer user.

Similarly, the product character is used in one embodiment to present product information. The product information may include background information, general operating instruction, specific uses of the product, advantages of the product, technical specifications or any other information the business desires to include about the product. The present invention contemplates prompting recognized voice commands of the consumer user to provide correct responses to questions asked by the product character or to acknowledge satisfaction with an answer provided by the product character. Progressive interaction between the product character and the consumer user advances the consumer user through the promotion instruction software.

In this regard, the voice interactive application can act to pique the consumer user's interest, thus compelling the consumer user to continue to interact with the promotional software. This interaction with the product character can function to build brand recognition and goodwill as the electronic display acts as a billboard personalized to the consumer user where the product character is presented continually in both visual and audio formats. Continued consumer user interaction with the voice interactive product character will invariably encourage purchases of the product at a substantially low cost per impression.

In one embodiment of the invention, the interactive promotional software includes a voice interactive screen saver application. The voice interactive screen saver provides a unique combination of screen saver and voice verification technology for improved business marketing, promotional and/or advertising purposes. The screen saver is a computer software program that controls the display of an image or series of images on a computer monitor when the computer is on but is idle. The screen saver is typically activated after a predetermined time beginning from a last action performed by the consumer user. It should be appreciated that the duration of the predetermined time can be set to include any suitable and desirable time period depending on the application and/or the needs of the consumer user.

Once activated, the screen saver can function until interrupted by a user input in the form of a keyboard input, movement of the computer mouse, or any other input suitable to interrupt the screen saver mode. Upon interruption by the user, the screen saver mode ends and the working environment or desktop is displayed. Alternatively, the screen saver acts as a tool for privacy prompting the user for a password or voice input before returning what was displayed on the computer monitor prior to activation of the screen saver to the display. In one embodiment, the entered password is compared to a stored password typically based on the preference of the consumer user. If the password is authenticated, the screen saver shuts down; otherwise, it continues to prompt for the correct password. If the prompt does not detect any user input, then it reverts to the screen saver mode.

Alternatively, the voice verification technology of the present invention provides a unique authentication tool for integration with the computer operable screen saver. In one embodiment, the consumer user is prompted to speak into the user interface such as a microphone operably connected to software which is processed by the software and is compared to the voice of the consumer user previously recorded and stored in the electronic device. As such, the screen saver can be utilized as a multi-media consumer user experience which, when interrupted, employs voice input recognition for authentication purposes. It should be appreciated that multiple voice recordings can be stored for authentication and activating the multi-media presentation customized to individual consumer users.

The voice activated screen saver can be modified in a number of suitable ways depending on the application and in order to make the screen saver more attractive for use by the end user. For example, if voice authentication is successful and/or if it fails, the screen saver can be modified to prompt the consumer user with a message, such as text, image, voice and/or the like, acknowledging same. If authentication is successful, the consumer user can be prompted, for example, with message, such as a multi-media display including voice, text and/or image output. The multi-media message can indicate that the consumer user has won a sweepstakes and then can further prompt the consumer user to connect to a web-site affiliated with the business in order to obtain the sweepstake's prize. By voice input, the consumer user can then navigate to the web-site.

It should be understood that various changes and modifications to the preferred embodiments of the present invention described herein will be apparent to those skilled in the art. Such changes and modifications can be made without departing from the spirit and scope of the present invention and without diminishing its intended advantages.

The invention is claimed as follows:

1. A method of providing a multi-media interactive promotional experience, said method comprising:
creating a visual component associated with a concept, product or service being promoted;
providing a computer application having voice and speech recognition capabilities for animating said visual component so that said visual component is responsive to verbal input; and
installing said application on a user device adapted to display said interactive visual component and receive verbal input from said user.

2. The method of claim 1, wherein the visual component is selected from the group consisting of a product character, an animated trademark, a corporate logo, a product representation and a product spokesman character.

3. The method of claim 1, wherein the computer application includes a screen saver.

4. The method of claim 1, which includes providing a hyperlink to a web-site in response to said verbal input.

5. The method of claim 1, which includes performing tasks in a computer operating environment in response to verbal input by the visual component.

6. The method of claim 1, wherein the user device is a computer.

7. An audio-visual interactive promotion comprising:
a visual component associated with a concept, product or service being promoted;
a software application having voice and speech recognition capabilities for animating said visual component so that said visual component is responsive to verbal input; and
a user device adapted to display said interactive visual component and to receive said verbal input from said user.

8. The promotion of claim 7, wherein the visual component is selected from the group consisting of a product character, an animated trademark, a corporate logo, a product representation and a product spokesman character.

9. The promotion of claim 7, wherein the response to verbal input by the visual component includes providing a hyperlink to a web-site.

10. The promotion of claim 7, wherein the response to verbal input by the visual component includes performing at least one software-related task for each recognized voice command of the user.

11. The promotion of claim 7, wherein the voice interactive application includes promotional instruction.

12. The promotion of claim 11, wherein the promotional instruction includes an educational lesson.

13. The promotion of claim 11, wherein the promotional instruction includes product information.

14. The promotion of claim 7, wherein the software application includes a screen saver.

15. The promotion of claim 7, wherein the user device is a computer.

16. A method of promoting a concept, product or business, said method comprising:
recording a first voice input from a consumer user;
storing features of said first voice input;
receiving a second voice input from a consumer user;
determining if said second voice input is the same as the first voice input;
activating a voice interactive application if said second voice input is the same as the first voice input, wherein said voice interactive application is based on a theme promoting said concept, product or business;
displaying to the consumer user a visual component, wherein said visual component is associated with the promoted concept, product, or business, and wherein said visual component is adapted to interact with a recognized voice command of the consumer user; and
performing at least one predetermined task associated with the recognized voice command of the consumer user.

17. The method of claim 16, wherein the voice interactive application includes a screen saver.

18. The method of claim 16, which includes instructing the consumer user through the visual component, wherein the visual component is selected from the group consisting of a product character, an animated trademark, a corporate logo, a product representation and a product spokesman character.

19. The method of claim 18, wherein instructing the consumer user includes providing a voice interactive educational lesson.

20. The method of claim 18, wherein instructing the consumer user includes providing voice interactive product information.

21. The method of claim 16, which includes customizing the voice interactive application to a consumer user.

22. The computer program product of claim 16, which includes updating the voice interactive application.

23. A method for business promotion, comprising the steps of:
providing a device adapted to operate a voice interactive application wherein the device is capable of prompting, receiving and processing voice input;
receiving a voice command into the device; and
activating the voice interactive application, wherein the voice interactive application is adapted to include interaction with a consumer user through a visual component.

24. The method of business promotion of claim 23, wherein the product character of said voice interactive application performs at least one task associated with a recognized voice command.

25. The method of business promotion of claim 23, wherein the voice interactive application for business promotion includes instructing the consumer user through the product character.

26. The method of business promotion of claim 25, wherein instructing the consumer user includes providing a voice interactive educational lesson.

27. The method of business promotion of claim 25, wherein instructing the consumer user includes providing voice interactive product information.

28. The method of business promotion of claim 23, wherein the voice interactive application for business promotion includes a screen saver.

29. The method of business promotion of claim 23, which includes customizing the voice interactive application to the consumer user.

30. The method of business promotion of claim 23, which includes updating the voice interactive application.

31. A computer program product on a media that is stored on a device adapted to operate a voice interactive screen saver for business promotion, the computer program product comprising:
computer readable code means for storing data representing the voice interactive screen saver;
computer readable code means for executing a plurality of commands to activate the voice interactive screen saver; and
computer readable code means for running the voice interactive screen saver.

32. An apparatus for business promotion comprising a device adapted to operate a voice interactive screen saver.

33. The apparatus of claim 32, wherein the apparatus is employed within a system for business promotion.

34. A method for business promotion, comprising the steps of:
providing a device adapted to operate a voice interactive screen saver wherein the device is capable of prompting, receiving and processing voice input;
inputting a voice command into the device; and
activating the voice interactive screen saver.
